(19) United States
(12) Patent Application Publication
(10) Pub. No.: US 2018/0154684 A1
(43) Pub. Date: Jun. 7, 2018

(54) EMBOSSING STAMP AND PRINTING PLATE HOLDER FOR THE EMBOSSING STAMP

(71) Applicant: Trodat GmbH, Wels (AT)

(72) Inventors: Konrad Riegler, Eberstalzell (AT); Helmut Lindner, Peuerbach (AT)

(73) Assignee: Trodat GmbH, Wels (AT)

(21) Appl. No.: 15/546,477

(22) PCT Filed: Jan. 4, 2016
(86) PCT No.: PCT/AT2016/050001

§ 371 Date: Jul. 26, 2017

(30) Foreign Application Priority Data
Jan. 29, 2015 (AT) A50065/2015

(51) Int. Cl. B44B 5/02; B44B 5/00; B44B 11/04; B41K 1/02

(52) U.S. Cl. CPC B44B 5/026; B44B 5/0023; B41K 1/02; B44B 11/04; B44B 5/0085

(57) ABSTRACT

The invention relates to an embossing stamp, comprising at least a base body, in which laterally a receiving element for receiving a printing plate holder and on a further side an actuator are provided, and the actuator is designed in such a way that it acts directly or indirectly onto the receiving element, in particular onto the printing plate holder, where in the base body a rotating axle of the actuator is provided, characterised in that the insertable printing plate holder comprises a receiving element, preferably with an embossing ornament, and the receiving element provides at least a positioning recess for inserting positioning elements such as letters, symbols and/or elements. Furthermore, the invention also relates to a printing plate holder, a receiving element and a positioning element.

The invention relates to an embossing stamp, a printing plate holder, a receiving element and a positioning element, as described in claims 10, 14 and 10.

Embossing stamps or so-called seal presses that are used for producing a relief image without colour on document/paper or photo are already known. Here the document/paper or photo is positioned between two sealing plates. The seal press is then compressed so that a relief is formed on the document/paper or photo by the seals provided in the seal press. There are a number of applications for the embossing stamps or seal presses. They give documents, certificates, brochures, invitations, business cards, etc., or even napkins an exclusive look. Many produce their own invitations and design monograms and designs for this. Another aspect is increased security against counterfeiting, so that appropriate seals are designed and manufactured for and applied by companies, notaries, organisations, architects or engineers.

For example, DE 20 2011 100 743 U generally discloses an embossing stamp comprising a base body (base), an actuator (pressing lever) and a printing plate holder (embossing unit). In this case, the actuator is rotatably connected to the base via a rotating axle, where the actuator is designed so that it acts directly onto a receiving device provided in the base. This actuator is formed by a lever that branches out into two force arms. For embossing, the object to be embossed (paper) is inserted into the printing plate holder, which is positioned in the receiving device on the base body, and the user subsequently exerts a downward pressure P1 onto the first end of the actuator via the actuator. Thus, the first force arm is formed from the distance between the first downward pressure P1 and the axis of rotation. Here, during the rotation of the actuator downward, a second pressure P2 is exerted, where the distance between the second downward pressure P2 and the rotation axis matches [the length of] the second force arm. The force moment of the first pressure P1 and the force moment of the second pressure P2 are identical.

Moreover, DE 20 2011 100 743 U discloses an embossing stamp comprising a base body (base), an actuator (pressing lever) and a printing plate holder (embossing unit). Here the actuator is rotatably connected to the base via a rotating axle, where the actuator is designed so that it now acts indirectly via a pressing element that is mounted on the actuator and on the basic body onto a receiving device provided in the base.

BR 8404986 A discloses an embossing stamp, which in turn is formed from a base body with a receiving device, an actuator in the form of a lever and a printing plate holder. Here the lever is mounted above the receiving device in the base body via a rotating axle. The base body is formed by two separate plate-shaped side walls, which are connected to each other by means of distance elements, spacers, screw connections, etc. For this purpose, corresponding recesses, slots, bores or the like are provided in the plate-shaped side walls. In this case, the actuator, in particular the one-part lever, is mounted between the two plate-shaped side walls rotatably via a continuous axis. The parts of this embossing stamp are formed of metal, so that these can withstand appropriately high compressive forces.

It is disadvantageous in the case of the aforementioned documents that for all seal presses or embossing stamps corresponding printing plates are produced from a metallic material, which are then inserted into the printing plate holder, so that there are no possibilities of adaptation other than complete exchange of the entire printing plate holder or of the entire printing plate.

The object of the invention is now to provide an embossing stamp and a printing plate holder in which individualisation of the impression is possible. At the same time, the aforementioned disadvantages are to be avoided.

The object of the invention is achieved by an embossing stamp in which the insertable printing plate holder comprises a receiving element, preferably with an embossing ornament, and at least one positioning recess for inserting positioning elements such as letters, symbols, and/or elements is provided in the receiving element.

It is advantageous in this case that an impression produced by the embossing stamp can be individually adapted to the user's own needs. Here it is also possible that a change in the impression can be made at any time, by the user simply exchanging the positioning elements. Thus, it is now possible for the first time that individualisation can be made in a simple and cost-effective manner for such paper perforations.

According to a special feature of the invention, the base body and/or the actuator have a modular design, in which the lateral walls are at least partially formed by plates that are positioned and fixated in relation to each other by half-shells and/or connecting elements, where the side walls of the base body and/or of the actuator are preferably made of a metal plate, carbon plate or aluminium plate, and the half-shells and/or connecting elements are preferably formed from plastic and consist of one or more parts. This achieves a very stable and cost-effective design of the embossing device, in particular of the embossing stamp.

According to a further embodiment, the receiving element (20) is connected to the printing plate holder (5), which is designed as a hybrid structure, and in which an embossing plate receptacle (15, 16) is formed from spring-elastic material or from plastic, in particular a high-performance plastic material with spring-elastic and low-friction properties. This makes it possible to use various, customisable print plate holders in the embossing stamp.

According to one feature, the receiving element is formed from a plastic material, for example from a 3D printer, and is preferably attached via an adhesive film to the printing plate holder, in particular with printing plates provided in the embossing plate receptacle.

According to a particular feature, means for positioning the insertable positioning elements, in particular snap-in connections, are provided in the positioning recesses of the receiving elements. Thus, it is advantageously achieved that a secure and stable fitting of the positioning elements in the positioning recess is achieved. Thus, it is also ensured that during the transport of the embossing stamp and the printing plate holder falling out of the positioning elements is prevented.

According to one feature, several positioning elements are detachably mounted to a holding frame. This enables the user to use his/her initials for customisation.

According to a particular feature, preferably each letter of the alphabet and preferably special characters are provided on the holding frame. Thus, the user can select from a variety of positioning elements, so that a high degree of customisation is possible.

According to a further feature, a removal aid for easier removal of the positioning elements from the positioning receptacles is provided in the printing plate holder or in the embossing stamp itself. As a result, a simple and fast possibility for exchanging the insertable positioning elements is advantageously achieved. This is advantageous in particular when the positioning element is to be exchanged very often, as, for example, in children's embossing stamps in the form of a toy.

According to a particular feature, the positioning elements, in particular the positive and negative forms, have different characteristics. This advantageously ensures that improper positioning elements cannot be inserted into the respective receiving element, since they do not fit into the positioning receptacle.

Furthermore, the object of the invention is achieved by a printing plate holder, in which a receiving element is preferably provided with an embossing ornament in the embossing plate receptacle, and at least one positioning recess for inserting positioning elements such as letters, symbols, and/or elements is provided in the receiving element. It is advantageous here that for the first time the possibility exists that a user can perform customisation and thus produce differing impressions according to his/her wishes.

According to an advantageous feature, the receiving element is formed from a plastic material, for example from a 3D printer, and is preferably attached via an adhesive film to the printing plate holder, in particular with printing plates provided in the embossing plate receptacle. Thus, a wide variety of receiving elements can be produced in a simple form. Further, by using a 3D printer, arbitrary positioning elements can be produced.

According to a further particular feature, means for positioning the insertable positioning elements are provided in the positioning recesses of the receiving elements, in particular snap-in connections. This advantageously ensures that exact positioning and a good fit of the positioning elements are achieved.

According to a further feature, a removal aid for easier removal of the positioning elements from the positioning receptacles is provided in the printing plate holder or in the embossing stamp itself. This makes it possible to easily remove the positioning elements for a swift exchange.

Furthermore, the object of the invention is achieved by a receiving element in which at least one positioning recess is provided for positioning elements.

It is advantageous in this case that this creates an option for easy customisation of such a seal press.

According to a further feature, the receiving element is formed from plastic material, in particular from a 3D printer. Thus allows cost-effective production. Furthermore, a very high degree of individualisation is achieved thereby.

According to a particular feature, the receiving element and the positioning elements comprise means for positioning, in particular a snap-in connection. As a result, it is advantageously achieved that a secure stop and a correct positioning are thereby achieved.

The object of the invention is also achieved by a positioning element in which the positioning elements are formed from plastic material. Here it is advantageous that very cost-effective and flexible production is possible.

According to a further feature, the insertable positioning elements are provided positively and negatively (mirror image) in a holding frame. This advantageously ensures that very high imprint quality is achieved.

According to a particular feature, the positioning elements comprise means for fastening in a positioning recess in a receiving element.

For a better understanding of the invention, this is explained in more detail with reference to the following figures.

The figures show:

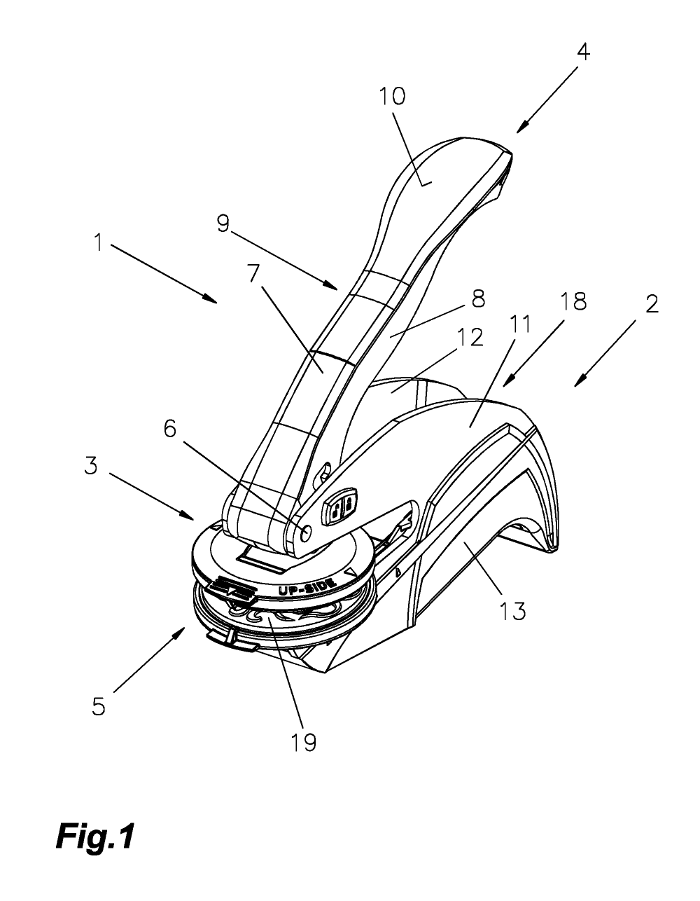

FIG. 1—a perspective view of an embossing stamp with inserted printing plate holder;

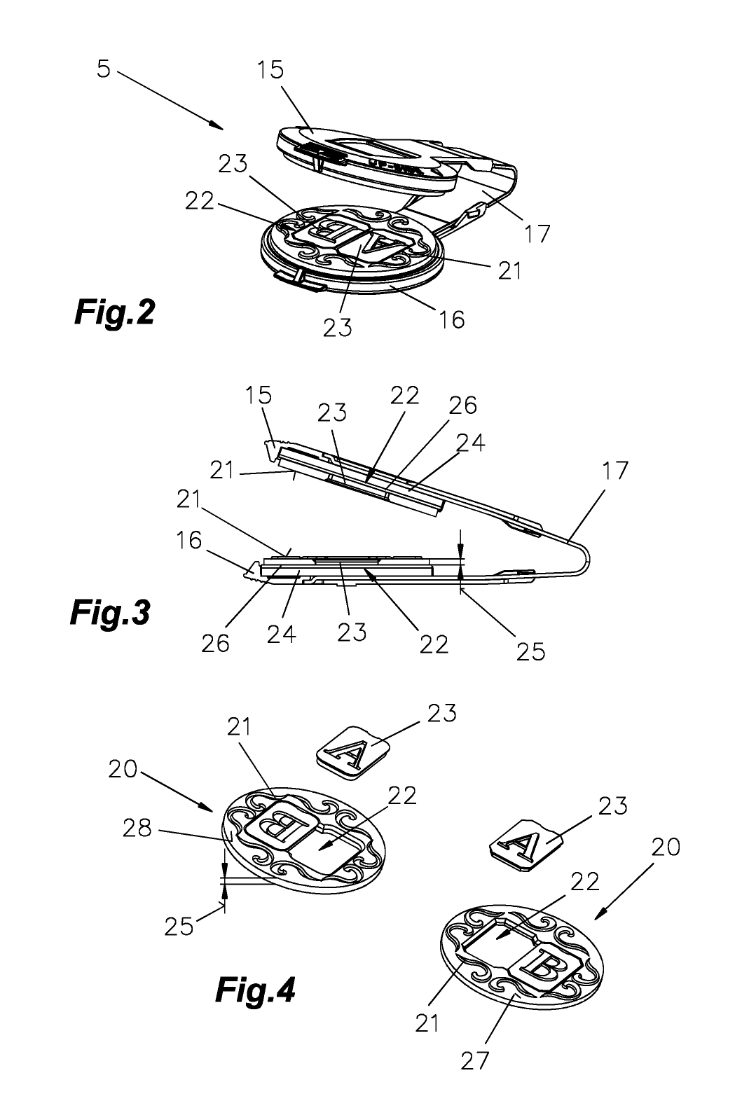

FIG. 2—a perspective view of the printing plate holder; simplified, for illustrative purposes only;

FIG. 3—a lateral view of the printing plate holder; simplified, for illustrative purposes only;

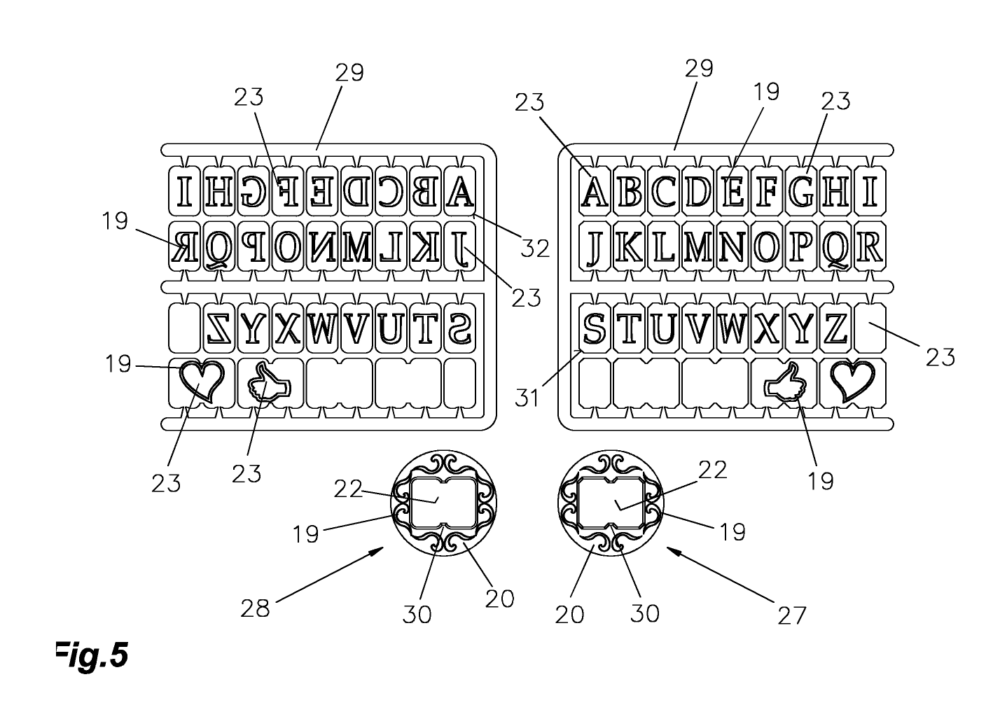

FIG. 4—a perspective view of a positioning receptacle and a corresponding positioning element; simplified, for illustrative purposes only;

FIG. 5—plan view of a holding frame for the positioning elements; simplified, for illustrative purposes only;

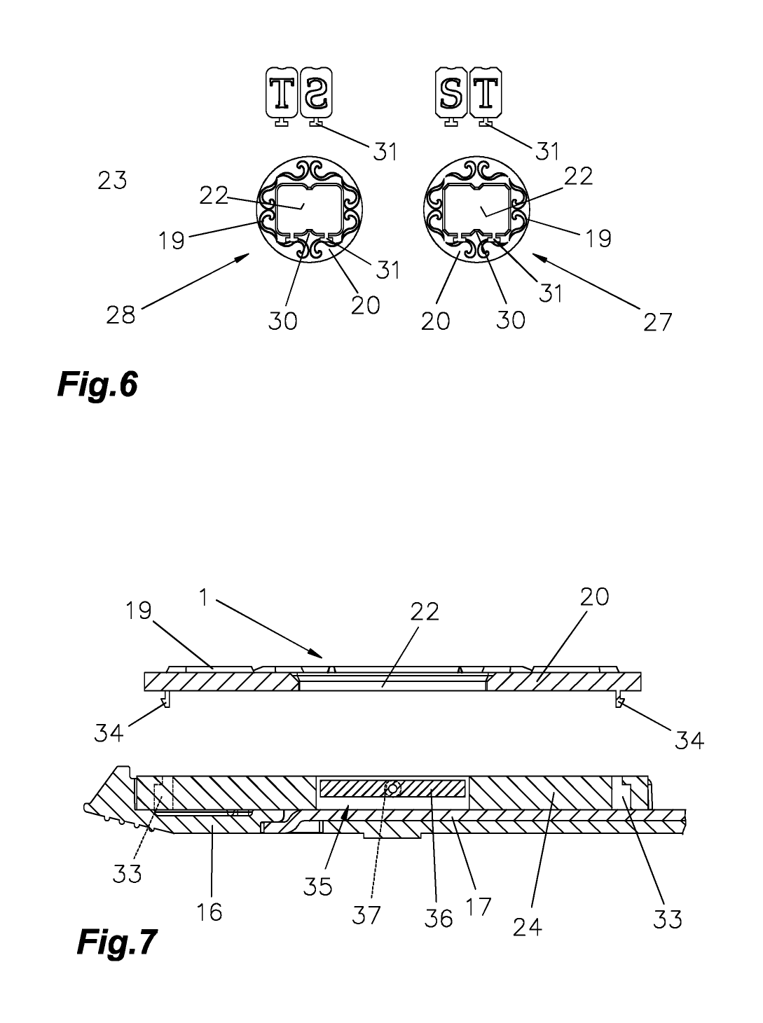

FIG. 6—an exemplary embodiment of a sectional view through the printing plate and the receiving element simplified, for illustrative purposes only.

It should be stated by way of introduction that, in the individual exemplary embodiments, identical parts are marked with the same reference numbers, wherein the disclosures contained in the entire description can, by analogy, be transferred mutatis mutandis to identical parts with identical reference numbers. The position details to be found in the description, such as, e.g., top, bottom, lateral, etc., relate to the figure immediately described and illustrated, and in the event of a change of position, they are to be transferred to the new position by analogy.

In FIGS. 1 to 5, an embossing stamp 1 or a so-called seal press for producing relief representations (not shown) on documents, paper or photos, etc., is shown, where the relief images are formed without colour. To allow formation of relief images, it is necessary for the embossing stamp 1 to exert high pressures on the document, paper or photograph, etc., so this must be very robust. This is achieved by the embossing stamp 1 being constructed, for example, from a plastic-metal combination being built from plates.

The embossing stamp 1 comprises a base body 2, in which a receiving device 3 is provided on one side and an actuator 4 on the opposite side. Here the actuator 4 acts directly or indirectly onto the receiving device 3, in particular onto a printing plate holder 5 provided therein, i.e. the printing plate holder 5 is compressed when the actuator 4 is actuated, that is during a pressing/embossing process. In order for such a pressing/embossing process to be possible, the actuator 4 is mounted in the basic body 2 via an axis of rotation 6, or the axis of rotation 6 of the actuator 4 is provided on the base body 2, respectively.

In the exemplary embodiment, the actuator 4, in particular a lever 7, comprises two plate-shaped side walls 8, 9 that are positioned or held at a defined distance by means of a handle element 10. To form the lever 7, the handle element 10 and the side walls 8, 9 are simply plugged together. Here the side walls 8, 9 are preferably made of metal, and the handle element 10 of plastic. This ensures that very high forces can be exerted on the lever 7, and at the same time, slipping is avoided by a non-slip or gripping plastic material.

Like the actuator 4, in particular the lever 7, the basic body 2 of the embossing stamp 1 is also designed in the form of a module, in particular being built from plates, and in turn consists of a plurality of individual parts. Here, too, a plastic-metal combination for the base body 2 is formed in order to achieve a very high stiffness with a very low weight. In the current exemplary embodiment according to FIGS. 1 to 5, side walls 11, 12 of the base body 2 are each formed by a plate which is positioned, fixated and held relative to one another via a half-shell 13 and/or connecting elements (not visible). The side walls 8, 9, 11, 12 of the base body 2 as well as those of the actuator 4 are formed from a metal plate or carbon plate or aluminium plate, etc., for which purpose materials that have a high stiffness or bending stiffness and resilience are preferably used, so that the user can exert a maximum of force onto the embossing stamp 1 during a pressing operation without the stamp deforming. The production of the individual parts is also substantially simplified, since no bending processes need to be carried out anymore. The individual parts, in particular the side walls 8, 9, 11, 12, the half-shells 13 and the handle element 10, are preferably produced by a punching operation or cutting operation and by injection moulding.

However, in order to be able to carry out an embossing process at all, it is necessary to insert the printing plate holder 5 with the printing plates 14 provided therein into the embossing stamp 1, as can be seen more clearly in FIGS. 2 and 3. The printing plate holder 5 comprises an upper and a lower embossing plate receptacle 15, 16, which are connected to one another via a guide belt 17. The printing plate holder 5 can be formed in one piece from plastic material, in particular a high-performance plastic material, where a metallic insert for the action of the lever 7 of the embossing stamp 1 is provided on the preferably upper embossing plate receptacle 15. Concerning the plastic material, preference is given here in particular to high-performance plastics with the designation PEEK, PPS, PSU, PES, PTFE, etc., although other non-mentioned plastics can of course also be used, in particular if these have similar properties. Preferably, however, the printing plate holder 5 is designed as a hybrid structure in which the embossing plate receptacle 15, 16 is made of plastic and the guide belt 17 of spring-elastic material. The width of the guide band 17 is designed such that it fits into an intermediate space 18 between the two side walls 11, 12 of the basic body 2. The embossing plate receptacle 15, 16 and the corresponding printing plates 14 are preferably round in shape and project laterally out of the basic body 2 on both sides. If the printing plate holder 5 is inserted into the receiving device 3, the predefined slide track of the receiving device 3 in the basic body 2 is designed in such a way that the two embossing plate receptacles 15, 16 are pressed together and simultaneously press the lever 7 upwards. Thus, after an embossing operation, when the force exertion on the lever 7 ends, said lever is pushed back into the initial position independently by the printing plate holder 5, and a new embossing operation can be carried out immediately. In principle, it can thus be said that when the lever 7 is actuated, i.e. during the execution of an embossing operation, the lever 7 presses onto the upper side of the embossing plate receptacle 15 and is thus pressed downwards in the direction of the second embossing plate receptacle 16, whereby the relief 19 represented on the printing plates 14 is pressed into the inserted document, paper or photo, etc.

According to the invention, it is now conceived that the insertable printing plate holder 5 comprises a receiving element 20, as can be seen more clearly in FIG. 4, with an embossing ornament 21, and in the receiving element 20 at least one positioning recess 22 is provided for the insertion of positioning elements 23, such as letters, symbols and/or elements. Preferably, a printing plate 24, preferably made of metal, is first inserted into the embossing plate receptacles 15, 16, as shown in FIG. 3, to which the receiving element 20 is subsequently fastened. It is thus ensured that the flexible, individually adaptable receiving element 20 has a low thickness 25 and can thus be produced cost-effectively. Of course, however, it would also be possible for the receiving element 23 to be designed in such a way that the printing plate 24 can be omitted and only a receiving element 23 of appropriate thickness inserted.

To allow a high degree of customisation, the receiving element 20 is formed from a plastic material, for example from a 3D printer, and is preferably attached via an adhesive film 26 to the printing plate holder 5, in particular with printing plates 24 provided in the embossing plate receptacle 15, 16. Thus, the user can create his/her desired relief 19 for the receiving element 20 on a computer and then simply print it out via a 3D printer, whereupon, after the printed receiving element 20 has cured, the latter is glued onto the printing plates 24. A positive and a negative form 27, 28 of the receiving element 20 (see FIG. 4) are automatically produced and printed out during the printing of the recording element 20 or by the software, which must be positioned accordingly.

In the illustrated embodiment of FIGS. 1 to 5, the adhesive film 26 is applied over the entire surface on the printing plate 24, so that this is present also in the area of the positioning recesses 22. The user can now detach a positioning element 23 from a holding frame 29 (see FIG. 5) and insert it into the positioning recess 22. Here the positioning recess 22 is designed in such a way that two individual positioning elements 23 or a double positioning element 23 can be used, where for this purpose a kind of separating web 30 is provided in the central region of the positioning recess 22, so that exact positioning of two individual positioning elements 23 is provided. In the case of the individual positioning elements 23, preferably letters are formed as relief 19, whereas in the case of the double positioning elements 23 symbols such as, for example, a heart, a Like icon, etc. are provided, i.e. a plurality of positioning elements 23 are detachably fastened to a holding frame 29, and on the holder frame 29 preferably each letter of the alphabet and preferably special characters are provided. Preferably, two holding frames 29 are provided for such a customisable embossing stamp 1, since positive and negative positioning elements 23 are in turn required for an embossing process with high embossing quality. It should be pointed out that, as is known in the art, the positive elements engage into the negative ones and therefore corresponding perforations with very high quality are formed in an embossing process in paper, cardboard, etc.

In order to achieve exact alignment of the positive and negative positioning elements 23, the positioning element 23 is first inserted into the positioning recess 22 of the positioning element 20 in the lower embossing plate receptacle 16. The negative positioning element 23 is subsequently placed onto the positioning elements 23, i.e. in the case of the positive positioning element 23 the negative positioning element 23, whereupon by compression of the seal press the superimposed positioning element 23 is positioned and fixated exactly in the receiving recess 22 of the receiving element 20 in the upper embossing plate receptacle 15. In such a procedure, very high relief quality is achieved, as automatic positioning of the insertable positioning elements 23 is performed automatically.

To prevent the positive 27 and negative 28 positioning elements 23 from being incorrectly inserted into the inverted receiving element 20, it is provided that these have different embodiments 32. For the positive positioning elements 27, for example, an angular, preferably 45-°, shape 32 is provided, whereas a rounded shape 32 is provided for the negative 28.

FIG. 6 shows a plan view of an exemplary embodiment in which means 31 for fixating the insertable positioning elements 23, in particular snap-in connections, are provided in the positioning recesses 22 of the receiving elements 20. Such means 31 can be of any desired configuration and are intended to support the rapid exchange and positioning of the positioning element 23. In this case, the adhesive film 26 in the region of the positioning recess 22 can be dispensed with.

In FIG. 7 an exemplary embodiment is shown, in which the printing plate 24 is likewise made of plastic material. Here the printing plate 24 is provided with latch openings 33, into which a latch pin 34 provided on the rear side of the receiving element 20 can be inserted, i.e. the receiving element 20 is simply pushed onto the printing plate 24, the latch pin 34 engaging into the detent opening 33, ensuring proper fit. The latch pin 34 is automatically created on the opposite side of the relief 19 when the receiving element 20 is produced.

Furthermore, a removal aid 35 is provided for easier removal of the positioning elements. The removal aid 35 can, for example, be formed by a simple rocker 36 that is pivoted by actuating a snap fastener 36 and thus lifts the positioning elements 23 positioned in the positioning recess 22 out of the receiving elements 20. It can thus be said that in the printing plate holder 5 or in the embossing stamp 1 itself a removal aid 35 is provided for easier removal of the positioning elements 23 from the positioning recesses 22.

In principle, it is possible for the positioning elements 23 to be inserted into the positioning receptacle 22 without adhesive film 26 and without means 31, the fixation being then formed exclusively by friction, i.e. as a friction connection. It is also possible that, instead of printing or in combination with it, the production takes place by injection moulding technology. For example, the receiving element 20 can be produced by means of 3D printing for maximum customisation of the design of the embossing ornament 21, whereas the positioning elements 23 are produced as mass products by injection moulding technology as inexpensively possible, since the degree of individualisation is not required here.

In the exemplary embodiments shown, thus a so-called typo-seal is shown, in which individual adaptation takes place by selection of various symbols or letters, which are easy to insert and replace. Here a wide variety of positive and negative symbols, in particular positioning elements 23, are shown, which are detachably fastened in an optionally present holding frame 29 and which can be inserted into a centring frame or receiving element 20 provided with a freely selectable embossing ornament 21 or nor, where the centring frame or receiving element 21 is fastened in a seal press or embossing stamp 1, in particular in a printing plate holder 5.

As a matter of form, it should finally be emphasised that, for the better understanding of the structure of the system 1 and its components and their constituent parts, the same have in part been represented not to scale and/or enlarged and/or reduced in size.

In addition, individual features or feature combinations from the various exemplary embodiments shown and described can inherently form independent inventive solutions or solutions according to the invention.

1. Embossing stamp, comprising at least a base body, in which laterally a receiving element for receiving a printing plate holder and on a further side an actuator are provided, and the actuator is designed in such a way that it acts directly or indirectly onto the receiving element, and the printing plate holder, where in the base body a rotating axle of the actuator is provided, characterised in that the insertable printing plate holder comprises a receiving element with an embossing ornament, and the receiving element provides at least a positioning recess for inserting positioning elements such as letters, symbols and/or elements.

2. Embossing stamp according to claim 1, characterised in that the base body and/or the actuator have a modular design, in which the lateral walls are at least partially formed by plates that are positioned and fixated in relation to each other by half-shells and/or connecting elements, where the side walls of the base body and/or of the actuator are preferably made of a metal plate, carbon plate or aluminium plate, and the half-shells and/or connecting elements are preferably formed from plastic material and consist of one or more parts.

3. Embossing stamp according to claim 1, characterised in that the receiving element is connected to the printing plate holder, which is designed as a hybrid structure, and in which an embossing plate receptacle is formed from plastic and a guide belt from spring-elastic material or from plastic, in particular a high-performance plastic material with spring-elastic and low-friction properties.

4. Embossing stamp according to claim 1, characterised in that the receiving element is formed from a plastic material, for example from a 3D printer, and is preferably attached via an adhesive film to the printing plate holder, in particular with printing plates provided in the embossing plate receptacle.

5. Embossing stamp according to claim 1, characterised in that in the positioning recesses of the receiving elements means, in particular snap-in connections, for fixating the insertable positioning elements are provided.

6. Embossing stamp according to claim 1, characterised in that several positioning elements are detachably mounted on a holding frame.

7. Embossing stamp according to claim 1, characterised in that on the holding frame preferably each letter of the alphabet and preferably special characters are provided.

8. Embossing stamp according to claim 1, characterised in that a removal aid for easier removal of the positioning elements from the positioning receptacles is provided in the printing plate holder or in the embossing stamp itself.

9. Embossing stamp according to claim 1, characterised in that the positioning element, in particular the positive and negative forms exhibit differing embodiments.

10. Printing plate holder according to claim 1 for an embossing stamp, comprising at least an upper and a lower embossing plate receptacle that are connected to each other by way of a guide belt, characterised in that a receiving element is preferably provided with an embossing ornament in the embossing plate receptacle, and at least one positioning recess for the insertion of positioning elements, such as letters, symbols, and/or elements, is provided in the receiving element.

11. Printing plate holder according to claim 10, characterised in that the receiving element is formed from a plastic material, for example from a 3D printer, and is preferably attached via an adhesive film to the printing plate holder, in particular with printing plates provided in the embossing plate receptacle.

12. Printing plate holder according to claim 10, characterised in that in the positioning recesses of the receiving elements means, in particular snap-in connections, for fixating the insertable positioning elements are provided.

13. Printing plate holder according to claim 10, characterised in that a removal aid for easier removal of the positioning elements from the positioning receptacles is provided in the printing plate holder or in the embossing stamp itself.

14. Receiving element according to claim 1 for use with a structure selected from the group consisting of an embossing stamp or a printing plate holder, characterised in that at least one positioning recess is provided for the insertion of positioning elements.

15. Receiving element according to claim 14, characterised in that the receiving element is formed from a plastic material, in particular from a 3D printer.

16. Receiving element according to claim 14, characterised in that the receiving element and the positioning elements provide means for positioning, in particular a snap-in connection.

17. Positioning elements for use with a structure selected from the group consisting of an embossing stamp, a printing plate holder, and a receiving element, characterised in that the positioning elements are formed from plastic materials.

18. Positioning elements according to claim 17, characterised in that the insertable positioning elements are provided positively and negatively (mirror image) in a holding frame.

19. Positioning elements according to claim 17, characterised in that the positioning elements provide means for fastening in a positioning recess in a receiving element.
